(19) United States
(12) Patent Application Publication
(10) Pub. No.: US 2006/0261657 A1
(43) Pub. Date: Nov. 23, 2006

(54) Core part of flat spring recliner for auto seat angle adjustment

(76) Inventors: Xianhu Luo, HuBei (CN); ZhengKun Huang, HuBei (CN)

Correspondence Address: BIRCH STEWART KOLASCH & BIRCH, PO BOX 747, FALLS CHURCH, VA, 22040-0747, US

(21) Appl. No.: 11/132,224

(22) Filed: May 19, 2005

(51) Int. Cl. B60N 2/02

(52) U.S. Cl. 297/367

(57) ABSTRACT

A kernel part of a kind of flat spring recliner includes four major sub-components Ratchet a ratchet gear piece, a cam unit, a return spring and cover. A better adjustment of the angle and a fold-flat of auto seat is achieved. The cam unit can be further divided into a runner plate, a slider piece, a locking cam and an unlocking cam which is placed in the lower sink of the geared piece. In, the upper circle thereof, two segments are geared in a symmetrical position. In the groove inside the runner plate, there are two-geared slider pieces fitted to engage with the ratchet gear tooth. The sliders are designed with bosses on the surface, which match with the kidney slots in the unlocking cam, and with self-locking side, which are driven by the self-locking side on the locking cam to move off center in translation.

### FIELD OF THE INVENTION

The present invention relates to a mechanism with the function of adjusting the seat back angle as well as achieving fold of seat in sedans or other vehicles.

### TECHNICAL BACKGROUND

Products under Chinese patent no.ZL99237062.0 and ZL01250171.9 are depicted as core part of flat-spring recliner that feature in high strength, broad adaptability, small clearance and are free of repair, whereas, they can not meet the requirement to adjust the angle of seat back and fold the seat at the same time. A solution to the problem is found in another Chinese patented recliner core part no. ZL02139265.x, which, however, shows its own disadvantage in that the strength of major driven parts slider and cam is not enough to ensure a qualified static strength of recliner, nor are they capable of realizing central self aligning.

### SUMMARY AND OBJECTS OF THE INVENTION

The object of the present invention is to provide a seat recliner with high strength, central self-aligning function and above all, the advantage of realizing fold and angle adjusting of seat back at the same time.

The structure of the present invention is made up of two major components: a double cam mechanism and a ratchet gear mechanism. The cams work to lock or unlock the seat back by driving the sliders to move inward or outward in translation. The ratchet gear work to lock or unlock the recliner through engagement or disengagement of gear teeth between the gear and slider.

The technical solution of the present invention includes a ratchet gear, cam unit, return spring which are packed together by the cover. The cam mechanism includes an unlocking cam, locking cam, runner plate and slider. The ratchet gear bears two layer of circle in it, one upper and the other lower in which lies the unlocking cam. Two sections inside the upper circle are toothed in a symmetrical position to achieve the seat angle adjustment, leaving two other symmetrical sections without teeth to realize the quick folding function of seat. The sliders are put on two ends of the slider groove which goes through center of the plate. Opposite to the center side on the sliders, there are gear teeth to function engagement with ratchet gear. Driven by the unlocking cam, the slider moves inward and outward in translation and can achieve self-locking when the sliders engage with the ratchet and unlock when disengaged.

With the above description, the present invention embodies in it the following features:

The locking cam is combined together with the unlocking cam with two bosses on the former fitted into correspondent holes in the latter.

The inner circle of runner plate matches with the outmost circular of the ratchet gear with a defined clearance, and the unlocking cam is allocated in the same way with the runner plate.

Within the self-locking section of locking cam, the friction angle always exceeds its lifting angle, ensuring a stable and reliable self-locking performance of the driving part.

The semi-pierced sink in the middle of runner plate is designed to locate the return spring with the purpose of reducing thickness of the whole core part. The return spring mentioned here is a scroll in shape, with the hooked head inserted into the hole in the runner plate and the other head winds around the square boss on the locking cam, the arrangement intends to tighten up the core setup. When working, the spring provides the force that sets the tendency for the slider and ratchet to engage with each other.

Adjusting increment is 1.93 degree/tooth.

The cover of the present invention also has two steps to act as the direct sheath for runner plate and ratchet gear respectively, and all the child parts are finally packed into a core part with the closing up of the cover.

The double cam mechanism provides a better solution to the imbalanced inner strengths.

When closed up with the cover, the core then becomes an integrated whole that cannot be taken apart and is free of repair. The core bears such high generality and stability that it can be fixed to various customer-specified mounting brackets in different vehicles. When fitted to auto seats, the recliner can stand much larger side torque.

Compared with other similar products, to sum up, this innovation features better in compact structure, small size, high strength, double sided unlocking capability, more precise angle adjusting as well as the ability to achieve center self aligning. Apart from the excellent angle setting function, this design also allows a quick fold of the seat back.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF DRAWING

The present invention will become more fully understood from the detailed description given hereinbelow and the accompanying drawings which are given by way of illustration only, and thus are not limitative of the present invention, and wherein:

FIG. 1 is the structural build of the present design; and

FIG. 2 shows FIG. 1 in another direction.

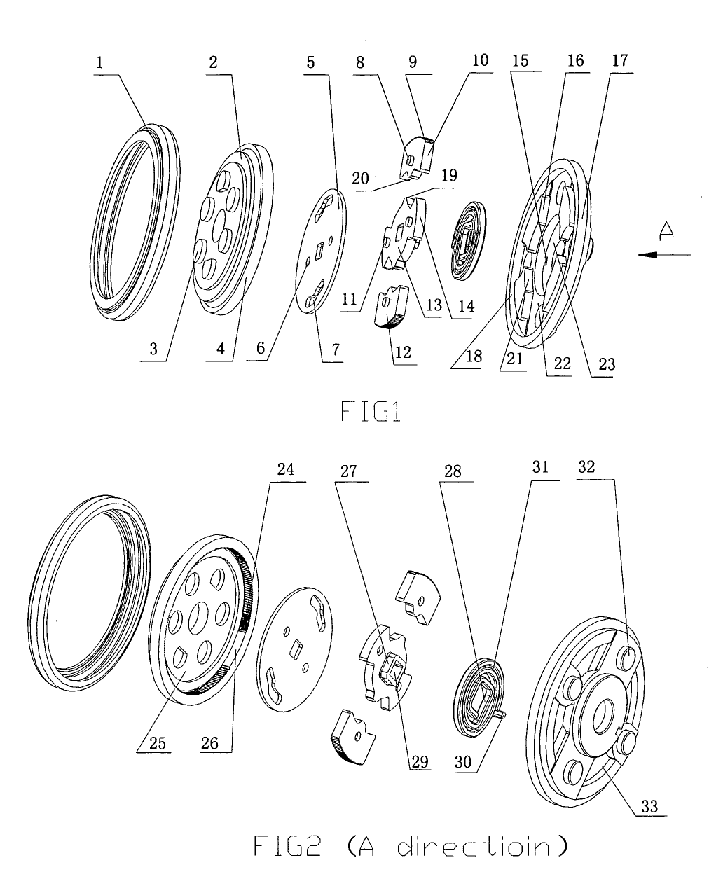

### DETAILED DESCRIPTION OF THE PREFERRED EMBODIMENTS

The following is a detailed description of the parts forming the present invention.
(1) Cover
(2) Ratchet gear
(3) Round boss on ratchet gear
(4) Upper circle of ratchet gear
(5) Unlocking cam
(6) Hole in unlocking cam
(7) Kidney slot
(8) Round boss on slider
(9) Tooth on slider
(10) Side face of slider
(11) Round boss on locking cam
(12) Slider
(13) Locking cam
(14) External circle of locking cam
(15) Hole in runner plate
(16) Side face of runner plate
(17) External circle of runner plate
(18) Inner circle of runner plate
(19) Self-locking side on the locking cam
(20) Self-locking side on the slider
(21) Inner curve of runner plate
(22) Groove in runner plate
(23) Semi-pierced sink in runner plate
(24) Ratchet gear tooth
(25) Lower step in ratchet gear
(26) Smooth section
(27) Square boss on locking cam
(28) Inner coil in return spring
(29) Square hole
(30) Hooked spring head
(31) Return spring
(32) Semi-pierced round boss on runner plate
(33) Runner plate

In the two pictures as the arrows indicate: there are two steps on the ratchet gear (2). In the upper one, there are two geared sections (24) and two other smooth sections (26) in symmetry position, and in the lower one (25) lies the unlocking cam (5), along with it (5), locking cam (13), runner plate (33) and slider (12) together build up the cam mechanism. The sliders (12) are set in grooves (22) of the runner plate (33) and slider side face (10) meets with groove side face (16), on the opposite side of slider the teeth (9) can engage with ratchet gear teeth. The sliders are designed with bosses (8) on the surface which match with the kidney slots (7) in the unlocking cam, and with self locking side (20) which is driven by the self locking side (19) on the locking cam to move outward in translation. The semi-pierced bosses (11) match with the holes (6) and they join the two cams (5 and 13) together. The semi-pierced sink (23) in the middle of runner plate is designed to locate the return spring (31), with the hooked head (30) inserted into the hole (15) in the runner plate and the other head coiled (28) to wind around the square boss on the locking cam. The external circle (14) matches with curve (21), and circle (4) matches with inner circle (18). The cover (1) has two steps to match with (17) and (4). All of the parts are finally packed into a core part with the closing up process of the cover.

When (9) engages completely with (24), (19) and (20) will lock up the core part and unlock otherwise.

The function process:

The semi-pierced bosses (3) on (2) are fixed to the upper bracket, which is then mounted to the seat back, while in the same manner, the 4 round bosses (32) on (33) are fixed to the lower bracket which is tied to the seat cushion. Apply torque, and the torque is transmitted through the square hole (29) in (13) to recliner core mechanism, where the cam (13) drives cam (5) to rotate clockwise, (5) pushes slider (12) to move center ward along (22) by the joint efforts of kidney slot (7) and the boss (8) which is located in (7). The movement continues till (9) and (24) declutch to enable (2) and (33) to turn freely along their matching surface, and that free movement helps to realize the seat angle adjustment; When the seat is positioned to a proper angle, stop application of torque, and now (31) will drive (13) to move clockwise, (19) touches (20) and with the force of their relative movement, (5) is pushed off centre along (22) till (9) completely engages with (24) and the lock formed between (19) and (20) helps fixing the seat at the chosen angle; Additionally, the recliner can also realize a fold-flat function when (9) is disengaged and is faced with the smooth section (26) where it can move freely without hindrance.

What is claimed is:

1. A kernel part of a kind of flat spring recliner comprised of four major sub-components: a ratchet gear piece, a cam unit, a return spring and cover wherein the cam unit can be further divided into a runner plate, a slider piece, a locking cam and an unlocking cam which is placed in the lower sink of the ratchet gear, in the upper circle thereof, two segments are geared in symmetry position in a groove inside the runner plate, there are two-geared slider pieces fitted to engage with the ratchet gear tooth, the sliders are designed with bosses on the surface, which match with the kidney slot in the unlocking cam, and with a first self-locking side that is driven by the second self-locking side on the locking cam to move off center in translation wherein.
when the two-geared slider pieces engage completely with the ratchet gear tooth, the first self-locking side and the second self-locking side they will lock up the core part and unlock otherwise.

2. The core part according to claim 1, wherein the locking cam is combined together with the locking cam with two bosses on the former fitted into correspondent holes in the latter.

3. The core part according to claim 1, wherein the circular sink face inside the runner plate matches with the outmost circular face of the ratchet gear with a defined clearance.

4. The core part according to claim 1, wherein the external circle of locking cam is allocated with the inner curve of runner plate in the same way as that of inner circle or the runner plate and the upper circle of the ratchet gear.

5. The core part according to claim 1, wherein within the self locking section of locking cam, the friction angle of self-locking surface always exceeds its lifting angle, ensuring a stable and reliable self locking performance of the driving part.

6. The core part according to claim 1, wherein the semi-pierced sink in the middle of runner plate is designed to locate the return spring.

7. The core part according to claim 1, wherein the return spring mentioned above is a scroll in shape, with the hooked head inserted into the hole in the runner plate and the other head winds around the square boss on the locking cam, the arrangement intends to tighten up the core setup, and wherein when at work, the spring provides the force that sets the tendency for the slider and ratchet to engage with each other.

8. The core part according to claim 1, wherein adjusting increment is 1.93 degree/tooth.

9. The core part according to claim 1, wherein the cover has two steps to act as the direct sheath for runner plate and ratchet gear respectively, and all the parts are finally packed into a core part with the closing up of the cover.
